(19) United States
(12) Patent Application Publication
(10) Pub. No.: US 2003/0213412 A1
(43) Pub. Date: Nov. 20, 2003

(54) Concrete utilizing recycled water-based paint

(76) Inventor: James Joseph Drew, Tsawwassen (CA)

Correspondence Address: NORMAN M. CAMERON, SUITE 1401 - 1166 ALBERNI STREET, VANCOUVER, BC, V6E 3Z3, CA

(21) Appl. No.: 10/146,822

(22) Filed: May 17, 2002

(51) Int. Cl. C04B 24/00

(52) U.S. Cl. 106/712; 106/724; 52/745.05

(57) ABSTRACT

A method of making a concrete slurry includes accumulating recycled latex paint in a batch sufficiently large so that the paint attains a desired, uniform color. The paint in the batch is mixed and macerated. The paint is then mixed with aggregate and cement. Preferably the color is a brown/gray color. In one preferred embodiment the paint comprises at least 50% by weight of liquid added to the slurry. The slurry may be used to produce concrete highway barriers.

### BACKGROUND OF THE INVENTION

This invention relates to recycling water-based paint and improvements to concrete, particularly highway barriers, by adding recycled water-based paint.

Environmental concerns have led to the collection of paints in an effort to properly recycle the paints instead of contaminating landfill sites. However, there remains the problem of suitably disposing of the paints and paint residues after they have been collected. The highest percentage of such paints today are water-based paints, commonly known as “latex paints”. Efforts have been made to recycle these paints, but desirable qualities of the paints have not been exploited to their full potential.

At the same time, problems have been encountered with exposed concrete surfaces, such as on highway barriers. The surfaces become contaminated with dirt and/or become covered with lichen, resulting in a decrease in visibility and a generally undesirable appearance. Also the surface paste tends to flake off. Water penetrates the porous surface. When the water freezes it pushes against aggregate below and flakes off the surface.

The use of latex paint has been described in the prior art, notably U.S. Pat. No. 4,043,826. This patent describes the use of latex paint in making an artificial rock molding. A binder composition is first formed which includes a curing agent and latex paint. Later cement and lightweight filler material are added. However this patent does not disclose the use of recycled latex paint per se. Also the amount of latex paint utilized may not be sufficient to impart favorable qualities to highway barriers and other exposed concrete surfaces.

U.S. Pat. No. 5,496,404 discloses the addition of latex paint to other ingredients including cement clinker. This is then pulverized. However the patent does not disclose a way of utilizing latex paint in liquid form.

U.S. Pat. No. 4,116,705 discloses the treatment of wastes, including latex wastes, by adding them to Portland cement mixture. However it appears that the latex utilized is in solid form.

U.S. Pat. No. 6,162,164 claims a method of recycling latex paint by agglomeration with fine particulates. The patent does not deal with production of concrete items.

Belgian Patent No. 842,206 claims a method of recycling a wide range of toxic substances including latex.

The prior art however does not disclose a method of utilizing recycled latex paint, or other water-based paints, in the making of concrete, or concrete items. Also it does not disclose a method of utilizing recycled latex paint which would greatly improve the qualities of highway barriers or other concrete items having exposed surfaces.

### SUMMARY OF THE INVENTION

According to one aspect of the invention, there is provided a method of making a concrete slurry. The method includes accumulating recycled latex paint in a batch sufficiently large so that the paint attains a desired, uniform color. The paint in the batch is mixed and macerated. The paint is then mixed with aggregate and cement. Preferably the color is a brown/gray color. In one preferred embodiment the paint comprises at least 50% by weight of liquid added to the slurry.

According to another aspect of the invention, there is provided a method of recycling water-based paint. Recycled liquid, water-based paint is accumulated in a batch sufficiently large so that the paint attains a desired, uniform color. The paint in the batch is mixed and macerated. The paint is then mixed with aggregate and cement to form a slurry

According to a further aspect of the invention, there is provided a method of making a highway barrier. Recycled water-based paint is accumulated in a batch sufficiently large so that the paint attains a desired, uniform color. The paint in the batch is mixed and macerated. The paint is mixed with aggregate and cement to form a slurry. The mixture of paint, aggregate and cement is placed in a mold shaped like the highway barrier and allowed to cure.

The invention also provides a concrete barrier made according to the above method.

The invention offers significant advantages compared to the prior art. It offers a practical way of utilizing recycled water-based paint to the maximum advantage. Paints of various colors can be used without affecting the color of the finished product. This is done by accumulating the paint in sufficiently large batches so that it attains a uniform color, typically gray/brown. This provides a pleasing appearance for a finished concrete product when the paint is added to a concrete mixture.

Furthermore, the paint is not added to the concrete as an inert ingredient, merely for purposes of disposing of the paint. Instead, the paint is added to the concrete in sufficient quantities to significantly improve the end product and not merely with respect to its appearance. The resulting concrete has low permeability which resists chloride ion attack encountered due to salt being applied to highway surfaces, for example. Also the concrete is easier to wash due to having a less porous surface. The concrete also has increased resistance to spalling. Since the surface porosity is significantly reduced, water does not tend to penetrate the surface and cause spalling or flaking of the surface paste when the water freezes. Thus resistance to weathering is considerably enhanced.

Highway barriers made according to the invention have improved visibility which enhances safety on the road. This is because they have a lighter color than ordinary weathered barriers, even when a surface layer of paint wears off. This is because the color is throughout the concrete.

A further advantage of products made according to the invention, such as highway barriers, is improved marketability, particularly to government departments which are encouraged to buy products having “recycled content”. It also improves the environment by utilizing recycled latex paints and effectively removing them from the environment as potential contaminants. Recycled latex paints are often available at a low price or in fact companies utilizing the invention may be paid to use the recycled paints.

### BRIEF DESCRIPTION OF THE DRAWINGS

In the drawings:

FIG. 1 is a flowchart showing a method of utilizing recycled water-based paints to make concrete highway barriers;

FIG. 2 is an isometric view, partly broken away, of a storage and mixing tank for the paint; and

FIG. 3 is a perspective view of a twin mold for making highway barriers according to an embodiment of the invention, one mold being partially filled with concrete.

### DETAILED DESCRIPTION OF THE PREFERRED EMBODIMENTS

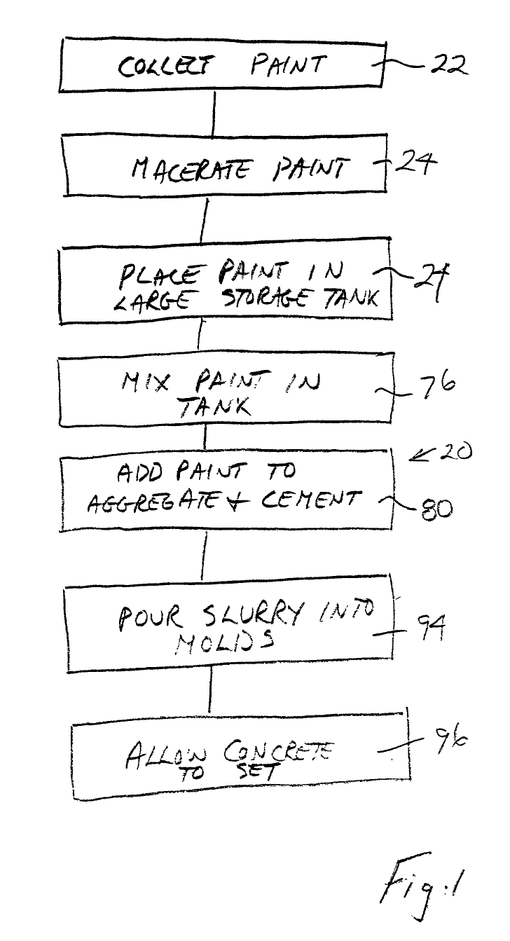

FIG. 1 illustrates a method 20 for utilizing water-based paints, particularly latex paints, in the production of improved concrete products, such as highway barriers. The paints utilized must be water-based paints in order to mix with water and/or chemically react with cement and thereby produce concrete. The most common water-based paints are “latex” paints. Three types of latex binders are commonly utilized in paints. Styrene-butadiene is the original binder used in latex paints and is still utilized for interior paints. Two other types are polyvinyl acetate (PVA) and acrylic. These last two binders are used for both interior and exterior surfaces. Recycled paints are typically mixtures of all three types of latex paints.

Leftover paints and paint residues are collected at recycling depots as indicated at 22 in FIG. 1. The paint is usually received in partially filled containers. The cans or other containers are opened at the recycling depots and the contents placed in a larger container. When sufficient paint has been accumulated, the mixture is taken to a site where concrete is to be made from the paint mixture. The collected paint and paint residue contain significant quantities of solids including hardened paint film. The mixture is therefore macerated, as seen at 24 in FIG. 1, in this example using a Dorrco Sulzer Disintegrator which is manufactured by Dorr-Oliver Long. Other such macerators, grinders or other equipment could be used to grind the solid material into smaller particles.

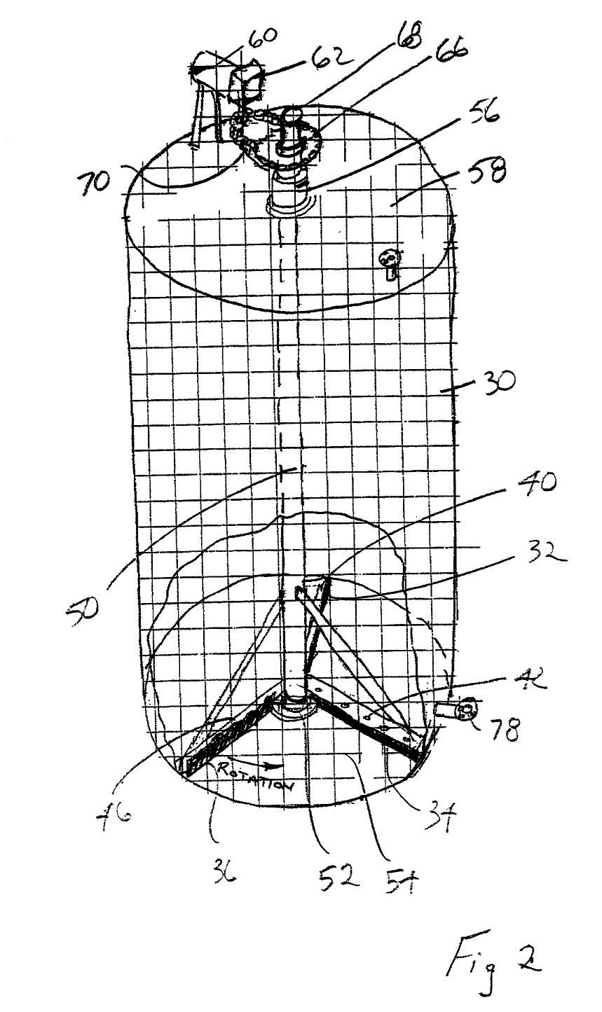

After the paint mixture is macerated, it is placed in a large storage tank as indicated at 26 in FIG. 1. Such a tank 30 is shown in FIG. 2. The tank in this example is a 5000-gallon tank although other sizes of tanks or other storage containers could be utilized. The particular tank in this example is 8 feet in diameter and 16 feet in height. The tank is provided with three rubber scrapers 32, 34 and 36 which are mounted on steel arms 40, 42 and 46 respectively. The steel arms are rigidly connected to a rotatable shaft 50 mounted on a bearing 52 at the center of bottom 54 of the tank. The shaft is also rotatable in a bearing 56 mounted on top 58 of the tank. In this particular example both bearings are bronze bearings though other bearings could be used.

An electric motor 60 and a gear reducer 62 are also mounted on the top of the tank and are operatively connected to sprocket 66 mounted on top 68 of shaft 50 via endless chain 70. The motor and gear reducer rotate the shaft 50 at a rotational speed of approximately 0.5 rpm in this example. The rubber scrapers prevent solids from accumulating at the bottom of the tank while the rotating arms and scrapers mix the paint in the tank as indicated at 76 in FIG. 1. The tank is provided with a normally closed discharge outlet 78 adjacent to the bottom.

After a large quantity of paint is in the tank, it tends to be a very consistent light brown/gray color. This produces concrete with a consistently lighter tone than conventional concrete.

When paint is desired, in order to prepare a concrete slurry, it is pumped from the tank via the outlet 78. The paint is then added to aggregate and cement and possibly other ingredients as indicated at 80 in FIG. 1. The paint may be macerated again after it is pumped from the tank.

In one example the paint is mixed with stone, sand, cement and a small quantity of water. The water added is largely comprised of water used to wash down the loading hopper and to clean other surfaces. In one example, provided below, a water reducing agent is also added. 25

The following is a table showing the quantities of ingredients utilized to prepare one cubic meter of concrete according to an example of the invention.

TABLE 1

| Ingredient | Volume | Weight | % Slurry by weight |
|---|---|---|---|
| 19 mm stone | | 630 kg | 26% |
| 10 mm stone | | 350 kg | 15% |
| concrete sand | | 970 kg | 40% |
| cement | | 320 kg | 13% |
| paint | 25 gal. | 112 kg | 4.6% |
| water | 6 gal. | 28 kg | 1.2% |
| water reducing | 5 litres | 5 kg | 0.2% |
| agent | | | |

It should be understood that the above example can be changed considerably according to the specifications of concrete to be produced. Generally the paint comprises 50%-80% by weight of liquid added to the slurry. The rest is water and water reducing agent. In the above example the paint comprises approximately 78 percent of the liquid added. The cement comprises approximately 13 percent of the slurry by weight, while the paint comprises approximately 4.6% of the slurry by weight. Generally it is preferred that the paint comprises least 2% of the slurry by weight and more preferably 2%-10%.

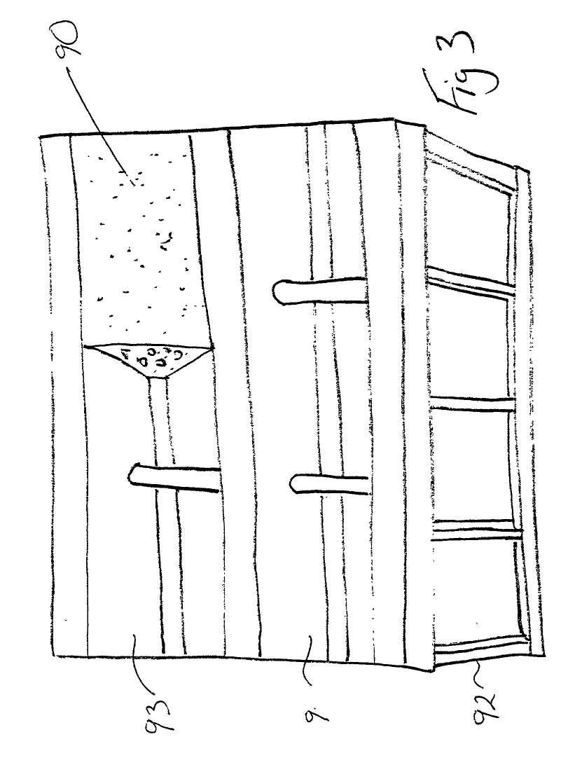

One particularly advantageous application of the concrete is highway barriers. For this purpose the concrete slurry 90, shown in FIG. 3, is poured into a twin mold 92 having two chambers 93 and 95, each of which is filled with concrete to produce a barrier. The concrete slurry is shown filling only part of chamber 93. This step in the process is indicated at 94 in FIG. 1. The concrete is allowed to set, as indicated at 96 in FIG. 1, thus producing a suitable highway barrier. The barrier thus produced is superior to barriers produced with conventional concrete because of the lighter color, resistance to spalling, surface flaking and chlorine ion attack as well as the increased ease of washing.

It will be understood by someone skilled in the art that many of the details provided above are by way of example only and are not intended to limit the scope of the invention which is to be interpreted with reference to the following claims.

What is claimed is:

1. A method of making a concrete slurry, comprising:
accumulating recycled latex paint in a batch sufficiently large so that the paint attains a desired, uniform color;
mixing the paint in the batch;
macerating the paint; and
mixing the paint with aggregate and cement.

2. The method as claimed in claim 1, wherein the color is a brown/gray color.

3. The method as claimed in claim 1, wherein the paint is liquid and comprises at least 50% by weight of liquid added to the slurry.

4. The method as claimed in claim 3, wherein the paint comprises 50%-80% by weight of liquid added to the slurry.

5. The method as claimed in claim 4, wherein the paint comprises 78% of liquid added to the slurry.

6. The method as claimed in claim 1, wherein the aggregate comprises 81% of the slurry by weight, the cement comprises 13% of the slurry by weight and the paint is liquid and comprises at least 2% of the slurry by weight.

7. The method as claimed in claim 6, wherein the paint comprises 2%-10% of the slurry by weight.

8. The method as claimed in claim 7, wherein the paint comprises 4.6% of the slurry by weight.

9. A method of recycling water-based paint, comprising:
accumulating recycled water-based paint in a batch sufficiently large so that the paint attains a desired, uniform color;
mixing the paint in the batch;
macerating the paint; and
mixing the paint with aggregate and cement to form a slurry.

10. The method as claimed in claim 9, wherein the color is a brown/gray color.

11. The method as claimed in claim 9, wherein the paint is liquid and comprises at least 50% by weight of liquid added to the slurry.

12. The method as claimed in claim 11, wherein the paint comprises 50%-80% by weight of liquid added to the slurry.

13. The method as claimed in claim 12, wherein the paint comprises 78% of liquid added to the slurry.

14. The method as claimed in claim 9, wherein the aggregate comprises 80% of the slurry by weight, the cement comprises 13% of the slurry by weight and the paint comprises at least 2% of the slurry by weight.

15. The method as claimed in claim 14, wherein the paint comprises 2%-10% of the slurry by weight.

16. The method as claimed in claim 15, wherein the paint comprises 4.6% of the slurry by weight.

17. The method as claimed in claim 9, wherein the paint is latex paint.

18. A method of making a highway barrier, comprising:
accumulating recycled water-based paint in a batch sufficiently large so that the paint attains a desired, uniform color;
mixing the paint in the batch;
macerating the paint;
mixing the paint with aggregate and cement to form a slurry;
placing the mixture of paint, aggregate and cement in a mold shaped like a highway barrier; and
allowing the mixture to cure.

19. The method as claimed in claim 18, wherein the color is a brown/gray color.

20. The method as claimed in claim 19, wherein the paint is liquid and comprises at least 50% by weight of liquid added to the slurry.

21. The method as claimed in claim 20, wherein the paint comprises 50%-80% by weight of liquid added to the slurry.

22. The method as claimed in claim 21, wherein the paint comprises 78% of liquid added to the slurry.

23. The method as claimed in claim 18, wherein the aggregate comprises 80% of the slurry by weight, the cement comprises 13% of the slurry by weight and the paint comprises at least 2% of the slurry by weight.

24. The method as claimed in claim 23, wherein the paint comprises 2%-10% of the slurry by weight.

25. The method as claimed in claim 24, wherein the paint comprises 4.6% of the slurry by weight.

26. The method as claimed in claim 18, wherein the paint is latex paint.

27. A concrete barrier made according to the method of claim 18.
